(19) United States
(12) Patent Application Publication
(10) Pub. No.: US 2003/0027051 A1
(43) Pub. Date: Feb. 6, 2003

(54) Manufacturing method and structure of electrodes for lithium based electrochemical devices

(76) Inventors: Joseph B. Kejha, Meadowbrook, PA (US); David Chua, Wayne, PA (US); Hsiu-Ping Lin, Princeton, NJ (US)

Correspondence Address: JOSEPH B. KEJHA, 1022 FREDERICK Rd., MEADOWBROOK, PA, 19046, US

(21) Appl. No.: 09/911,036

(22) Filed: Jul. 23, 2001

(51) Int. Cl. H01M 4/64; B05D 5/12; B05D 1/18

(52) U.S. Cl. 429/233; 429/241; 427/58; 427/436

(57) ABSTRACT

An economical manufacturing method and structure of electrodes for lithium based electrochemical devices, such as batteries and capacitors, which method results in the electrodes having various metal foil or grid current collectors embedded in the middle of their thickness by continuous dipping of said collectors in an electrode slurry, which is then solidified. The electrodes have superior performance and low resistance, due to short electron's travel to the collector, excellent adhesion of the electrode material to the grid, and uniform thickness at unlimited width. The method also includes additional steps and treatments to produce high quality electrodes.

### CROSS REFERENCE TO RELATED DOCUMENTS

The subject matter of the invention is shown and described in the Disclosure Document of Joseph B. Kejha Ser. No. 490,150 filed on Mar. 8, 2001, and entitled “Coating Method and Structure of Electrodes for Lithium Based Batteries.”

### BACKGROUND OF THE INVENTION

1. Field of the Invention

This invention pertains mostly to the coating method and structure of electrodes for lithium based electrochemical devices, which electrodes have embedded in the middle of their thickness an electrically conductive solid metal foil, expanded metal foil or grid or perforated metal foil as a current collector.

2. Description of the Prior Art

Prior art electrodes for lithium batteries have an active material with a binder, coated as a layer on one side (or on the top) of a substrate or current collector, such as metal foil, or in some instances the electrode material is coated on a plastic carrier film as a layer, which is then later peeled-off and pressed onto a metal grid or expanded foil. Another method employs fibrous web, such as carbon fiber woven or non-woven fabric, or metalized plastic fabric coated with, or embedded-in the active material, which fabric may be then pressed onto a metal grid or expanded foil current collector, or a metal foil terminal, or vice-versa, as described in the U.S. Pat. No. 6,080,267. Prior art U.S. Pat. No. 5,587,253 discloses an electrode which also has an embedded grid in the middle by pressing two electrode films onto both sides of the grid. Although these methods are adequate for certain applications, all of them are costly, labor intensive and difficult, or have size limitations due to non-uniform coating thickness. The pressed-on foils, or grid current collectors often separate, or do not adhere well to the electrode layer, thus causing reliability or low conductivity problems. Prior art methods to coat electrode material directly on metal grids has been unsuccessful. The electrode structures of the invention, which have embedded metal grid in the middle of their thickness by the coating method of the invention do not suffer from prior art problems and provide superior conductivity and many other positive advantages.

### SUMMARY OF THE INVENTION

It has now been found, that the electrodes for lithium batteries, such as lithium polymer, lithium-ion and lithium-ion-polymer batteries, and other electrochemical devices can be made easily by dip-coating electrode active materials in the form of a slurry, directly on expanded foils, or metal grids, or perforated metal foils, or even solid metal foils, which are preferably specially treated, and then this dip-coating is let to solidify by solvents evaporation, drying, heating, cross-linking, radiation, or other well know methods. The active material's slurries may comprise an active material, such as various oxides, lithiated oxides, halides, sulfites, etc., or graphite, or mesocarbon microbeads (MCMB), and a carbon black, and a polymer binder, such as polyvinyldiene fluoride (PVDF) homopolymer, and a solvent, and preferably a mixture of at least two solvents, such as acetone (AC) and N-methylpyrrolidinone (NMP). The NMP dissolves the PVDF homopolymer and the AC controls the viscosity of the slurry and evaporates rapidly after coating, which causes the solidification of the coating. The NMP is then evaporated by increasing heat. Preferably, there are no plasticizers in the slurry. The solidification of the coating causes it to be attached to the grids or various foils. The dip-coating provides for an electrode with the grid, or expanded, or perforated foil, or solid foil as a current collector and coating carrier being embedded in the middle of the uniform thickness coating of unlimited width, which is very beneficial for the electrical current collection, due to the shorter travel distance of the electrons through the thickness of the electrode. This method makes also possible the manufacture of large cells. Porousness or openness of the grids also provides for ionic access to the active material on both sides of the grid. The solid foil is useful as a current collector in the middle of bi-cells. The viscosity of the slurry and the uniform, constant speed of the carrier grid through the slurry controls the thickness of the coating and provides for uniform thickness of the coating at any width and length of the grid, or other carriers. The grid length is pulled over rollers through a dip-tank containing the slurry vertically upward and then is wound onto a spool. The slurry should be continuously mixed during coating to prevent settling of particles. It has been also found that success of the dip-coating and its adhesion to the grid or various foils, and its low electrical resistance also depends greatly on the treatment or priming of the grids or foils, prior to dip-coating by active materials. The preferred treatment of the aluminum grid, which is usually used in cathodes of lithium ion cells, or electrodes of capacitors is a water based primer comprising a mixture of a solution of lithium polysilicate and carbon black in distilled water, and may be applied also by dip-coating and drying, or by other methods. After treatment, the grid is baked to remove the water. This primer is not dissolved or does not washes off by the slurry solvents, and the carbon black makes it electrically conductive. The preferred treatment of the copper or other metal grid, which may be used in a lithium-ion cell's anode is made preferably by dip-coating a mixture of carbon black and a thin solution of PVDF homopolymer in at least two solvents, such as AC and NMP, onto the grid. After the AC evaporation, the grid is baked in air or vacuum to remove the NMP and thus attach the PVDF homopolymer to the metal. This primer also does not washes off during the coating of electrode materials later. The described structures are also useful in electrodes of various electrochemical devices, such as capacitors and supercapacitors.

Another embodiment of this invention is the finding, that the grids or various foils to be ultrasonically welded or otherwise attached later in the cells can be masked in the weld attachment area by solvent resistant tapes which are not too adhesive, so that they can be easily peeled-off after coatings. The masking tapes prevent the treatment and electrode coating of the grid (or various foils) in the area of the intended weld/attachment, referred to as the terminal tab. The tapes are then removed, preferably before the cutting of electrode leafs from the coated electrode length.

Another embodiment of this invention is the finding, that the grids or various foils can be cleaned in the intended area of the terminal tab and the electrode material coatings can be removed by sand blasting or buffing and vacuuming out the loose particles, while using a template shield to protect the active area coating of the electrode. A length of coated electrode is simply pulled through a sand blasting or buffing machine, creating for example, cleaned uncoated strips of the grid at the sides of the electrode length. The sides may be later notched to create terminal tabs.

The principal object of this invention is to provide electrodes for lithium based electrochemical devices, which are easy to manufacture repeatably by simply dip-coating active materials directly on the metal grids, while having uniform thickness at unlimited width and length.

A further object of this invention is to provide electrodes for high rate lithium based electrochemical devices, which are highly electronically conductive and have an excellent ionic and electronic access to the active material through their entire thickness.

A further object of this invention is to provide electrode structure for lithium based electrochemical devices, which have excellent integrity and improved adherence of the active material coating to the grids or various foils and low resistance, by embedding the grid in the middle of the coating, and by solvent resistant and electrically conductive treatment of the grid or foil.

A further object of this invention is to provide method of manufacturing of electrodes for lithium based electrochemical devices, by simply dip-coating the grids, or various foils with solvent resistant, electrically conductive primers, and dip-coating the active materials on top of the primers.

A further object of this invention is to provide a simpler method of manufacturing of electrodes for lithium based electrochemical devices, which eliminates the use of plasticizers and extraction step, and the pressing of electrode films on the grids.

A further object of this invention is to provide methods of preventing the coatings of the primer and/or the active material on the terminal tab area of the grid, or cleaning and removing the coatings from the terminal tab area.

Other objects' and advantages of the invention will be apparent from the description and claims.

### BRIEF DESCRIPTION OF THE DRAWINGS

The nature and characteristic features of the invention will be more readily understood from the following descriptions taken in connection with the accompanying drawing forming part hereof in which:

FIG. 1 is a diagrammatic, side elevational, and partly sectional view of the dip-coating machine, illustrating various components and their locations.

FIG. 2 is a top elevational view of the coated of the coated electrode length, illustrating the terminal tabs, masking tapes, and cutting lines of electrode leafs.

FIG. 3 is a cross sectional view of the coated electrode width, at the section line 3-3 of the FIG. 2, illustrating the location of the grid masking tapes, and the coating.

FIG. 4 is a top elevational view of the electrode leaf, illustrating the active area, and the terminal tab.

FIG. 5 is a cross sectional view of the electrode leaf at the line 5-5 of the FIG. 4, illustrating the grid embedded in the middle of the coating.

FIG. 6 is diagrammatic, side elevational view of the sand blasting and buffing machine, having an electrode length pulled through.

Like numerals refer to like parts throughout the several views and Figures.

It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Lithium based electrochemical devices and for example lithium-ion-polymer prismatic battery cell usually comprises, two flat electrodes, each with metal foil current collectors on the outside, and a polymer electrolyte separator between the electrodes. The separator is in the polymer type cell welded or adhesively joined to both electrodes and holds the cell together. The electrodes are usually manufactured by reverse roll horizontal coating on solid metal foils, or by casting on release film and then pressing onto metal grid current collectors. The releasers films are then peeled off.

The present invention employs a different and simpler method for manufacturing of the electrodes, which method results in an improved electrode structure with many advantages.

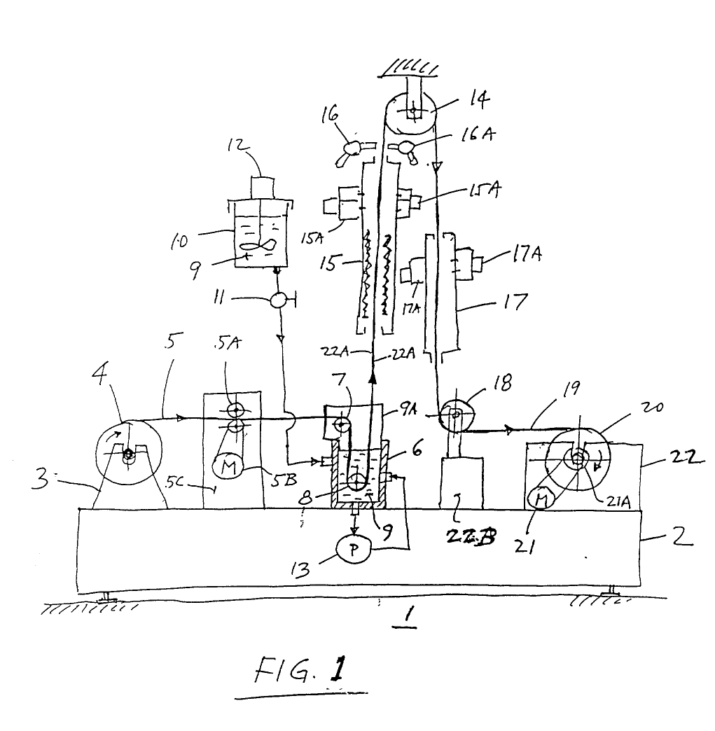

Referring now in more detail, particularly to the drawings of this patent and FIG. 1, one embodiment of this invention utilizes a simple vertical dip-coating method of the electrode active materials directly on the metal grids, or expanded foils, or perforated foils, or solid foils by the dip-coating machine, which may be well known in principle, but modified dip-coater for production of composite printed circuit boards. For example, the coater 1 includes base 2, which has attached to it feed spool support 3 with spool 4. The spool 4 may have wound on it a length of metal grid 5 having a desirable width, and this grid length is fed into nip rollers SA, driven by variable speed motor 5B, mounted on support 5C, and then the grid 5 travels through the dip-tank 6 over the rollers 7 and 8, which are supported by rack 9A. Motor 5B controls the speed of the grid 5. The dip-tank 6 contains an electrode slurry 9, which may include an active electrode material, such as a lithiated oxide or graphite powder, or mesocarbon microbeads (MCMB), a carbon black, such as Super-P (Eurachem,Belgium), a polymer binder, such as polyvinyldiene fluoride (PVDF) homopolymer, and a solvent and preferably, a mixture of at of at least two solvents, such as acetone (AC) and N-methylpyrrolidinone (NMP). Other solvents may be tetrahydrafuran (THF) and dimethylformamide (DMF). For example, the NMP dissolves the PVDF homopolymer and the amount of AC controls the viscosity of the slurry. The PVDF homopolymer binder maler possible higher loading of electrodes with active materials, because less of this binder is needed, as opposed to prior art PVDF copolymer. Other components can be added into the slurry. The slurry 9 may be replenished from the tank 10 by opening the valve 11, which may be automated. Both tanks 6 and 10 should have the slurry continuously mixed by pump 13 and mixer 12 to prevent the settling of particles. Preferably, there should be no plasticizers present in the slurry. The grid length 5 is then pulled vertically upward over the roller 8 and through solidification chamber 15, which may be an infrared heat dryer with an air flow through it to remove the solvents by blowers 15A. The slurry coating on the grid 5 may be solidified by the solvent evaporation and especially by acetone evaporation, but other solidification methods are possible, like UV or electron beam radiation curing, cross-linking etc. The solvent evaporation is preferred. The NMP may be then dried out by increased heat, for example, from hot air blowers 16 and 16A. The grid coating must be solidified, at least on the surface, before touching the roller 14. The grid may be then optionally pulled over the roller 14 downward through an optional dryer 17 with blower(s) 17A and under roller 18. Additional heat may be then applied for example, by additional hot air blowers (not shown), before the coated grid, or now the electrode length 19 may be wound onto spool 20, which is driven by an adjustable but constant speed overdrive motor 20, with slip clutch 21A, to keep the grid 5 in tension. The spool 20, motor 21 and clutch 21A are mounted on the support 22. The support 22 is also attached to the base 2. All electrical components may be connected to control box 22B.

It should be noted that this vertical dip-coating is made possible by using a mixture of at least two solvents, and then by faster, but gentle evaporation of at least one lighter solvent, as not to create blisters, and by subsequent removal of the remaining solvents by additional heating. The solidification of the coating 22A makes it to adhere to the grid 5, and because the grid 5 is embedded in the middle of the coating, it is a very beneficial electrode structure for less electrical resistance, due to shorter electron's travel distance to the collectors through the thickness of the electrode. This method provides superior conductivity as compared to prior art embedding of the grid by pressing two layers of electrode films on it. Because the grid is porous, it also permits a good access to the active material on both sides of the grid. The thickness of the coating is controlled by the viscosity of the slurry and by the speed of the grid being pulled through the slurry. Various grid opening sizes and/or flattening of the grid also effects the “pick-up” and thickness. The solid metal foil may be useful as a current collector in the middle of bi-cells, or bi-polar capacitors.

Example of cathode electrode slurry mix by % (percent) range of weight is:

| | |
|---|---|
| Lithiated cobalt oxide | 24 to 37% |
| carbon black | 1.6 to 8% |
| PVDF homopolymer | 1.6 to 8% |
| NMP | 6 to 18% |
| Acetone | 42 to 54% |

Example of cathode viscosity range is: 700 to 900 cp.

Example of cathode thickness range is: 3 to 16 mils+/−2% to 5%, after solidification

Example of anode electrode slurry mix by % (percent) range of weight is:

| | |
|---|---|
| MCMB | 24 to 37% |
| carbon black | 1.0 to 5% |
| PVDF homopolymer | 1.6 to 8% |
| MNP | 11 to 23% |
| Acetone | 42 to 54% |

Example of anode viscosity range is: 300-900 cp.

Example of anode thickness range is: 3-10 mils+/−2% to 5%, after solidification

Example of the range of the speed of the grid carrier through the dip tank is: 3-7 feet/min. for both electrodes.

The preferred grid for lithium-ion cells is 1.5 mil thick, with diamond shaped openings size 0.031 inch, such as manufactured by Delker Corp., Branford, Conn.

This dip-coating method also provides for uniform thickness of the coating at unlimited width, and length. This method makes thus possible the manufacture of large cells. This coating method is also applicable for manufacturing of electrodes for lithium polymer cells, prismatic liquid electrolyte lithium ion cells, or rolled liquid electrolyte lithium ion cells, hybrid lithium ion cells, lithium metal primary cells, and various capacitors like super capacitors, double layer capacitors, ultracapacitors, and many other electrochemical devices. The entire coater maybe also enclosed in a dry inert atmosphere box (not shown).

It has been also found that the successful coating of the grid, or various foils, having low electrode resistance, also depends on the treatment, or priming of the grid, or foil, prior to the coating with the active materials. It is assumed that the grids or foils are clean of oils or dirt, prior to the priming. The grid, or foils, for cathode of lithium ion, or lithium ion-polymer cells is usually of aluminum metal, and the grid, or foil, for anode is usually of copper metal. The aluminum grid's preferred treatment may be preferably done by dip-coating in a water based primer, such as the one comprising a solution of lithium-polysilicate and carbon black in destined water. The carbon black makes it electrically conductive. The water is evaporated by heating above 100° C. in air, and optionally later by vacuum drying. The water based primer does not dissolve in the slurry solvents later. The copper or other metal grid's preferred treatment may be done by simple dip-coating in 1% to 5% solution of PVDF homopolymer in a mixture of acetone and N-methylpyrrolidinone. A carbon black should be also added. After the acetone evaporation, the grid may be baked in the range of 220 C to 300° C. for 2 sec. to 2 minutes in air, to remove the NMP, and later the grid may be vacuum dried. This treatment also does not wash-off by the slurry solvents later.

Example of the preferred aluminum grid primer mix by % (percent) weight range is:

| | |
|---|---|
| Lithium polysilicate | 4 to 8% |
| carbon black | 0.5 to 2% |
| Destilled H₂O | 90 to 95.5% |

Example of the preferred copper grid primer mix by % (percent) weight range is:

| | |
|---|---|
| PVDF homopolymer | 1 to 5% |
| carbon black | 0.3 to 1.5% |
| NMP | 10 to 3O% |
| Acetone | 63.5 to 88.7% |

Both primer grid treatments may be done by the similar dip-coater machine as for the electrode's active material coating, as shown in FIG. 1, except the slurry 9 is replaced by the primer solution 39, as shown in FIG. 7. However, for the water based aluminum grid primer, the coater may be modified as follows: Because the water based mixture tends to run-off fast, the aluminum grid length exiting from the dip-coating tank 6, should be immediately, after the exit from the solution, bent 90° over a roller 43 and may be horizontally pulled onto the spool 20, by-passing thus the top roller 14. Instead of the dryers 15 and 17, for example two hot air guns 40 and 41 on top and bottom of the grid may be applied, immediately after the 90° bend, to quickly evaporate the water and to dry the primer. This is another embodiment of the invention.

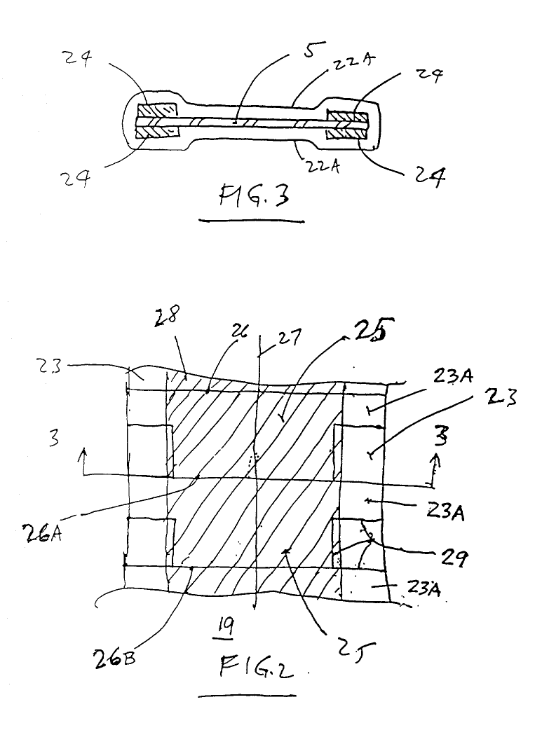

Referring now to FIGS. 2 and 3, another embodiment of this invention is illustrated. It was found, that the grids or various foils to be ultrasonically or otherwise welded, or electroconductively attached later in the cells can be masked in the intended weld/attachment area 23 by solvent resistant adhesive tapes 24, which are not too adhesive, so that they can be easily peeled-off after the coating, without destroying the foil or grid. The masking tapes prevent the primer and electrode coating 22A application on the grid (or various foils) 5 in the area of the intended weld/attachment, referred to also as the terminal tab 23A. The uncoated strips 23 may be optionally notched at lines 29 to create the terminal tabs 23A. The tapes 24 should be removed preferably before the cutting of the electrode leafs 25 from the coated electrode length 19 at the lines 26, 26A, 26B, and 27, and before notching at the lines 29. An example of the masking tape is the brown plastic (polypropylene) postal shipping tape.

The leafs 25 may be also cut in one step by a well known die cutter.

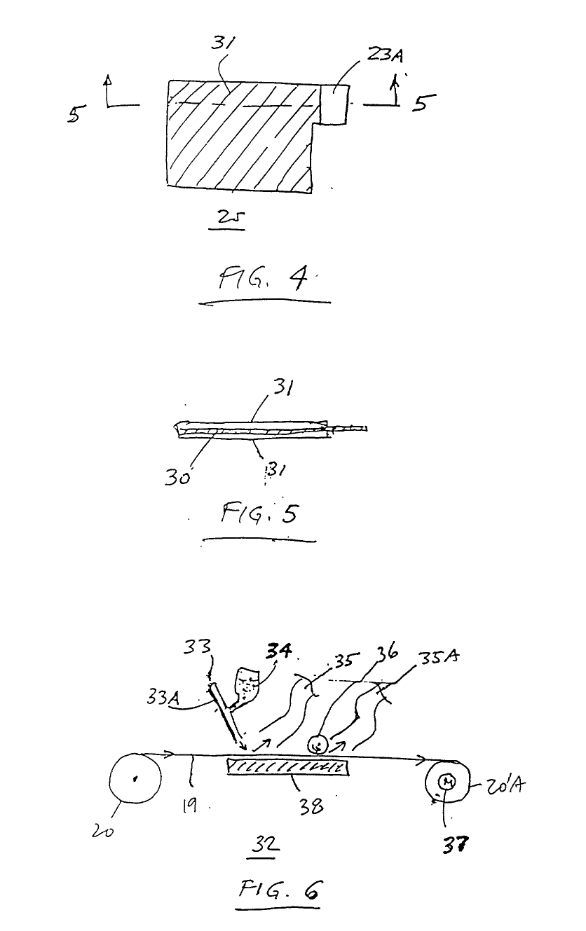

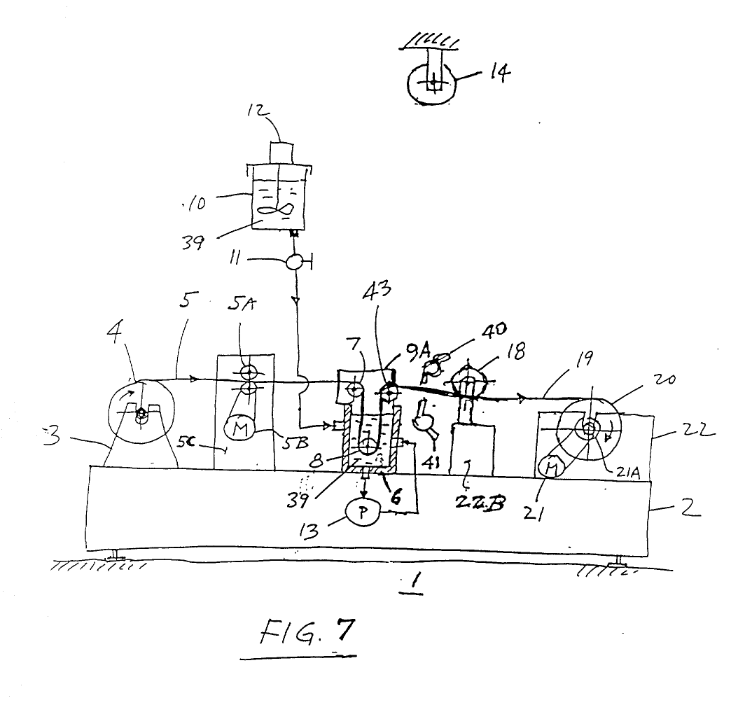

Another embodiment of this invention is the finding that the grids or various foils can be also cleaned after the coating without the tapes 24 in the intended area of the weld 23, or terminal tab 23A, and that the electrode material coatings 22A can be thus removed by sand blasting or buffing and vacuuming out the loose particles, while using a template shield (not shown) to protect the active area coating 28, (shaded area) of the electrode length 19. The length of coated electrode 19 may be simply pulled twice from the spool 20 through a sand blasting or buffing machine 32, as shown in FIG. 6, creating for example uncoated (cleaned) strips 23 at the both sides of the electrode length 19. The strips 23 may be later optionally similarly notched at lines 29 to create terminal tabs 23A. For example, the machine 32 may have a pressurized air 33 sucking sand 34 directed through nozzles 33 onto the electrode length 19. The sand maybe then vacuumed out by a well known vacuum system's hose 35. Similarly, the buffing wheel 36 loosens the coating 22A, which may be then removed by vacuum hose 35A. The electrode length 19 may be flipped up side down between the pullings, in order to clean its both sides. The cleaned length 19 is wound onto spool 20A and may be supported by table 38. Referring now to FIGS. 4 and 5, where the resulting electrode leaf 25 and its structure is illustrated, which is another embodiment of the invention. For example, the electrode leaf 25 may comprise the grid, or expanded foil, or perforated foil 30 which is cut to size from the grid length 5, which is embedded in the active material coating 31, as shown in FIG. 5. The coating 31 is cut to size from the coating 22A. Notching the clean (uncoated) area of the grid results in terminal tab 23A, which may be later welded to another cell's terminal tab, for example when stacks of the cells are assembled, (not shown). The electrode leaf 25 should be also consolidated or compressed under heat and pressure to increase its density, before assembly into a cell. This step may be also done before the cutting of the electrode length 19 into the leafs 25, by a well known calendering machine.

It should, of course be understood that the description and the drawings herein are merely illustrative and it will be apparent that various modifications, combinations and changes can be made of the structures and the systems disclosed without departing from the spirit of the invention and from the scope of the appended claims. It will thus be seen that a more economical and reliable method for lithium based electrochemical devices' electrodes manufacturing, and an improved electrode structure has been provided with which the objects of the invention are achieved.

We claim:

1. Manufacturing method of electrodes for lithium based electrochemical devices, in which a length of a metal grid is dip-coated by an active material slurry, and said length is then pulled vertically upward through a solidification chamber, in which said dip-coating is solidified.

2. Manufacturing method of electrodes for lithium based electrochemical devices, in which a length of an expanded metal foil is dip-coated by an active material slurry, and said length is then pulled vertically upward through a solidification chamber, in which said dip-coating is solidified.

3. Manufacturing method of electrodes for lithium based electrochemical devices, in which a length of a perforated metal foil is dip-coated by an active material slurry, and said length is then pulled vertically upward through a solidification chamber, in which said dip-coating is solidified.

4. Manufacturing method of electrodes for lithium based electrochemical devices, in which a length of a solid metal foil is dip-coated by an active material slurry, and said length is then pulled vertically upward through a solidification chamber, in which said dip-coating is solidified.

5. Manufacturing method of electrodes for lithium based electrochemical devices, as described in claim 1, in which said length of said grid is treated by a solvent resistant and electrically conductive primer, prior to said dip-coating.

6. Manufacturing method of electrodes for lithium based electrochemical devices, as described in claim 2, or 3, or 4, in which said length of said foil is treated by a solvent resistant and electrically conductive primer, prior to said dip-coating.

7. Manufacturing method of electrodes for lithium based electrochemical devices, as described in claims 1, or 2, or 3, or 4, in which said slurry includes at least two solvents, a carbon black and a polymer binder.

8. Manufacturing method of electrodes for lithium based electrochemical devices, as described in claim 7, in which said solvents include acetone in the range of 42 to 54 weight % (percent) and N-methylpyrrolidinone in the range of 6 to 23 weight % (percent), said polymer binder is polyvinyldiene fluroride homopolymer in the range of 1 to 8 weight % (percent), said active material is in the range of 24 to 37 weight % (percent), and said carbon black is in the range of 1 to 8 weight % (percent).

9. Manufacturing method of electrodes for lithium based electrochemical devices, as described in claim 5 or 6, in which said primer is a mixture of a solution of lithium polysilicate in water and a carbon black.

10. Manufacturing method of electrodes for lithium based electrochemical devices, as described in claim 5 or 6, in which said primer is a mixture of a carbon black and a solution of polyvinyldiene fluoride homopolymer in at least two solvents.

11. Manufacturing method of electrodes for lithium based electrochemical devices, as described in claim 5 or 6, in which said length has masked areas of intended terminal tabs by solvent resistant adhesive tapes, prior to said primer treatment, and said adhesive tapes are removable.

12. Manufacturing method of electrodes for lithium based electrochemical devices, as described in claim 1, or 2, or 3, or 4, or 5, or 6, which additionally includes an electrode cleaning step of intended terminal tabs area by buffing and vacuuming after said coating.

13. Manufacturing method of electrodes for lithium based electrochemical devices, as described in claim 1, or 2, or 3, or 4, or 5, or 6, which additionally include an electrode cleaning step of the intended terminal tab area by sand blasting and vacuuming after said coating.

14. Manufacturing method for lithium based electrochemical devices, as described in claim 5, or 6, in which said primer is a mixture of a solution of lithium polysilicate in water and a carbon black, and a said length is dip-coated by said primer and is pulled over a roller horizontally after dipping while hot air is applied on said coating.

15. Electrode structure for lithium based electrochemical devices, which includes a metal grid and an electrode material coating on said grid, the improvement therein said grid is embedded in the middle of said coating by a dip-coating method.

16. Electrode structure for lithium based electrochemical devices, which includes an expanded metal foil, and an electrode material coating on said foil, the improvement therein said foil is embedded in the middle of said coating by a dip-coating method.

17. Electrode structure for lithium based electrochemical devices, which includes a perforated metal foil and an electrode material coating on said foil, the improvement therein said foil is embedded in the middle of said coating by a dip-coating method.

18. Electrode structure for lithium based electrochemical devices, which includes a solid metal foil and an electrode material coating on said foil, the improvement therein said foil is embedded in the middle of said coating by a dip-coating method.

19. Electrode structure for lithium based electrochemical devices, as described in claim 15, or 16, or 17, or 18, in which said grid or foil is treated by a solvent resistant and electrically conductive primer before said coating.
